(19) United States
(12) Patent Application Publication
(10) Pub. No.: US 2006/0225574 A1
(43) Pub. Date: Oct. 12, 2006

(54) Filter element and filter system

(75) Inventors: Volker Braeunling, Heppenheim (DE); Daniel Schmitt, Birkenau (DE); Robert Bader, Heidelberg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 11/401,056

(22) Filed: Apr. 10, 2006

(30) Foreign Application Priority Data
Apr. 12, 2005 (DE) DE 10200501677.6

(51) Int. Cl. B01D 53/02

(52) U.S. Cl. 96/154

(57) ABSTRACT

A filter element, including a filter body having an inflow side and outflow side, the filter body being constructed in layers, at least one layer including granular adsorbents and at least one further layer including activated carbon fibers. The filter element may be used in a filter system which ensures optimum utilization of the load capacity of the filter element used in that a first layer, which includes activated carbon fibers is assigned to the inflow side and a second layer, which includes granular adsorbents, adjoins this layer on the outflow side. A filter system includes the filter element.

This claims the benefit of German Patent Application No. 10 2005 016 677.6 filed Apr. 12, 2005 and hereby incorporated by reference herein.

The present invention relates to a filter element, including a filter body having an inflow side and an outflow side, the filter body being constructed in layers, at least one layer including granular adsorbents and at least one further layer including activated carbon fibers. Furthermore, the present invention relates to a filter system.

### BACKGROUND

Filter elements of this type, which combine granular adsorbents and planar formations made of activated carbon fibers, are known. The granular adsorbents are situated in this case upstream from the planar formations made of activated carbon fibers. Situating the granular adsorbents upstream from the activated carbon fiber layer should cause a particularly favorable absorption of pollutants contained in the air. Part of the pollutants contained in the air—the adsorptives—is absorbed by the granular adsorbents and another part passes through the layer of granular adsorbents. It is a disadvantage in this case that the granular adsorbents frequently have not yet reached their maximum load of adsorbate and nonetheless a majority of the pollutants flow past them. The adsorptives passing through the granular adsorbents are then adsorbed in an activated carbon fiber layer.

In particular, the problem results that adsorptives which could have been absorbed by the capacity of the granular adsorbents also pass through the activated carbon fiber layer insufficiently filtered. Because of this behavior of the filter elements forming the species, it cannot be ensured that a space which is to be protected from air loaded with pollutants is contaminated as little as possible.

The filter elements known from the related art thus have significant disadvantages in regard to their efficiency and effective utilization of their load capability.

### BRIEF SUMMARY OF THE INVENTION

The present invention is therefore based on an object of providing a filter system which ensures optimum utilization of the load capacity of the filter element used. Accordingly, the filter element of the present invention is characterized in that a first layer, which includes activated carbon fibers, is assigned to the inflow side and a second layer, which includes granular adsorbents, adjoins this layer on the outflow side.

It was first recognized according to the present invention that the filter elements of the prior art have significant disadvantages. In a second step, it was then recognized that activated carbon fibers are characterized by high adsorption rates because of their dimensions. In a third step, it was then recognized that the system of the layers according to the present invention surprisingly makes it possible to achieve a high adsorption capacity. Furthermore, it was recognized that the system according to the present invention causes a smaller proportion of air loaded with pollutants to pass through the first layer unfiltered. Finally, it was recognized that the system according to the present invention causes a higher adsorption rate of the overall system. A combinatorial effect is thus implemented by the system according to the present invention, which is expressed in the increase of the adsorption capacity and the adsorption rate with optimum utilization of the load capacity of the filter element. The object thus may be achieved.

The granular adsorbents may include activated carbon. Activated carbon is characterized by particularly good absorption capability for nearly all relevant adsorptives.

Entirely as a function of the chemical or physical properties of the adsorptives, zeolites, cyclodextrins, silicates, ion exchangers, or aluminosilicates may also be used as granular adsorbents. It is conceivable to use these materials in mixture or in pure form.

A third layer, which includes activated carbon fibers, may adjoin the second layer. This concrete embodiment allows a “sandwich-type” construction of the filter body. This ensures that air loaded with pollutants which passes the granular activated carbon unfiltered is subjected to a renewed and effective filtering by activated carbon fibers. The thickness of the layers may be selected as a function of the pollutant load. It is also conceivable for the thickness of the individual layers to be selected as a function of the type of adsorptive. It is conceivable that a first adsorptive is preferentially adsorbed in the first layer, a second adsorptive is preferentially adsorbed in the second layer, and a third adsorptive is preferentially adsorbed in the third layer, for example. The layered construction of the filter body thus allows selective adaptation to different adsorptives.

At least one layer which includes activated carbon fibers may be designed as a nonwoven. The use of a nonwoven is advantageous since its structure is stable and thus allows manufacturing and handling of the filter body without problems.

The layers which include activated carbon fibers may contain further fibers or particles in addition to the activated carbon fibers. This embodiment allows the mechanical stability, porosity, and elasticity of the activated carbon fiber layer to be set. Furthermore, it is possible for specific quantities of activated carbon fibers to ensure homogeneous equidistribution of the fibers in the nonwoven. It is conceivable for a nonwoven to be used in which 30% to 70% activated carbon fibers are incorporated. The fibers to be added to the activated carbon fibers may be made of polyamides, polyolefins, polyesters, or other thermoplastic materials. The selection of these materials allows thermal bonding of the fibers to one another without problems. Bicomponent fibers, in particular cladded core fibers, may also be used as binder fibers. For this purpose, it is advantageous that the core and the cladding may be manufactured from materials having different melting points and therefore different stabilities. Thermal bonding at high stability may thus be implemented without problems. It is also conceivable to scatter activated carbon particles or particles of other adsorbents in the activated carbon fiber layer in order to modify the adsorption behavior selectively.

The layers which include granular adsorbents may contain further fibers or particles. For this purpose, it is conceivable for a layer to include 90% granular adsorbents and 10% fibers or other particles. The load with granular adsorbents may also be selected to be lower entirely as a function of the mechanical requirements which are placed on the filter body.

The activated carbon fibers may have a diameter of at most 20 μm. The selection of the diameter from this range has been shown to be particularly advantageous in regard to the adsorption rate and adsorption capacity.

Activated carbon particles used as granular adsorbents may have a size which is in the range from 0.25 mm to 0.85 mm. This range has proven to be a good compromise between adsorption rate, adsorption capacity, and pressure drop. The specified range corresponds to the unit 20 mesh×60 mesh (mesh size according to ASTM Designation D 2862-97). The granular activated carbon particles may also be in the range from 10 mesh to 150 mesh in order to implement a satisfactory adsorption behavior. The lower the size selected for the activated carbon particles, the greater the adsorption rate. Experimentally, an optimum between high adsorption rate and high adsorption capacity as well as low pressure drop was able to be ascertained when the size of the particle was selected from the specified range.

A layer loaded with granular adsorbents may have a mass per unit area of 100 g/m² to 500 g/m². The selection of the mass per unit area from this range ensures that the filter body has a satisfactory adsorption behavior. Furthermore, this mass per unit area implements adequate mechanical properties for the layer, which ensure its fitness for use.

A layer loaded with activated carbon fibers may have a mass per unit area of 10 g/m² to 200 g/m². The selection of the mass per unit area from this range has been shown to be particularly advantageous to ensure good adsorption behavior of the filter body with low pressure drop. In particular, it was possible to ascertain experimentally that the specified mass per unit area of activated carbon fibers, in combination with the mass per unit area specified above in regard to granular activated carbon, ensures particularly good results in regard to the adsorption capacity and adsorption rate.

The filter element may have a progressive construction. Such a construction does not have a sharp separation between neighboring layers. Rather, the layers are designed as areas which pass smoothly into areas of different material consistencies. This intermeshing construction allows particularly solid material bond between the individual layers and a uniform manufacturing process.

The filter element may have layers which include areas of different material concentrations. In particular, it is conceivable for this purpose that gradients in regard to specific material concentrations are implemented within a layer. This construction allows the increase of the absorption capacity in the downstream direction, for example, if the adsorbent concentration in the downstream direction increases.

The object may also achieved by a filter system including a filter element, it being possible for unfiltered air loaded with adsorptive to flow against an activated carbon fiber layer.

The filter element in all of the possible embodiments described above may be used in motor vehicles or also in the construction industry. When used in the automobile industry, the filter element may be provided in a filter system which is to protect the interior of the motor vehicle from air loaded with pollutants. This use and effect is also conceivable in the construction industry, for example, in connection with air-conditioning systems. It is also conceivable against this background for the filter element to be used in respiratory protection masks.

The filter element described here may also be used in room air purifiers. Room air purifiers are typically not permanently installed, but rather represent mobile devices which are used in buildings or also in motor vehicles.

### BRIEF DESCRIPTION OF THE DRAWINGS

There are various possibilities for implementing and refining the teaching of the present invention advantageously. Reference is made to the following explanation of preferred exemplary embodiments of the present invention with reference to the drawings. Preferred embodiments and refinements of the teaching are also explained in general in connection with the explanation of the preferred exemplary embodiments of the present invention with reference to the drawings, in which:

FIG. 1 shows a diagram which represents the chronological breakthrough characteristic over time of air loaded with pollutants on four filter elements; and

FIG. 2 shows schematically a filter system according to the present invention.

### DETAILED DESCRIPTION OF PREFERRED EMBODIMENTS

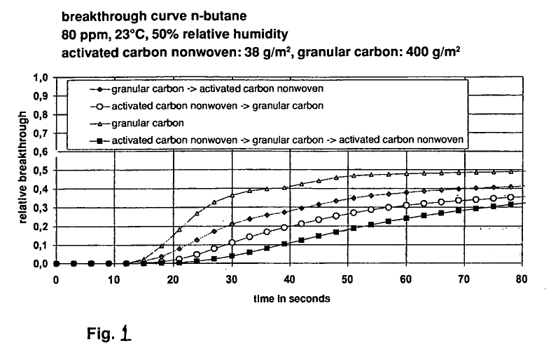

FIG. 1 shows a diagram in which the breakthrough behavior of four filter elements is shown, two of the filter elements being in accordance with the present invention and two beign for comparison purposes.

The curve identified using squares shows the behavior of a filter element having a sandwich-type construction according to the present invention. This includes a first layer made of an activated carbon fiber nonwoven having 38 g/m² mass per unit area, a second layer of granular activated carbon having 400 g/m² mass per unit area, and a third layer which is identical to the first layer. The activated carbon fiber nonwoven is thus on the inflow side, and the second layer adjoins this layer in the direction of the outflow.

Furthermore, the curve identified using circles shows a filter element according to the present invention in which an activated carbon fiber layer and having a mass per unit area of 38 g/m² is situated on the inflow side. This is followed by a layer having granular activated carbon, which has a mass per unit area of 400 g/m².

The curve identified using diamonds represents a filter element for comparison with the two filter elements according to the present invention in which the layer having granular activated carbon is situated on the inflow side.

Finally, the curve identified using triangles shows a filter element for comparison which only includes a layer of granular activated carbon having a load per unit area of 400 g/m².

The comparative measurements were performed at 23° C. and a relative ambient humidity of 50%. N-butane having a concentration of 80 ppm was used as the test gas.

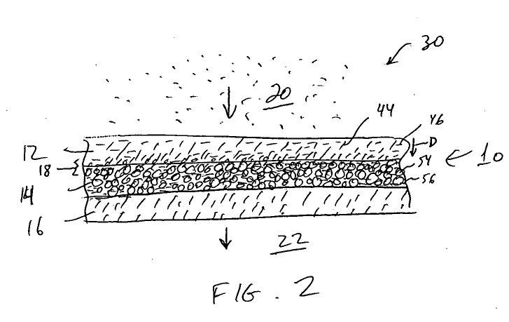

FIG. 2 shows schematically a filter system 30 with an inflow side 20 having unfiltered air loaded with adsorptives and a filtered air outflow side 22. A filter element 10 according to the present invention has a layer 12 on an inflow side, the layer 12 including activated carbon fibers 44 and other fibers 46, for example from a nonwoven. A granular adsorbent layer 14 next the layer 12 in the direction of the outflow side is provided and may have granular adsorbents 54 as well as other fibers 56. An optional activated carbon fiber layer 16, for example one similar to first layer 12 may be provided. In an area 18 the layers 12, 14 may intermesh so that for example some adsorbents 54 are found in layer 12 and some activated carbon fibers 44 are found in layer 14 in this area. Also, layers 12, 14 may vary in the concentration of the carbon fibers 44 and adsorbents 54 respectively in a direction D so that for example more fibers 44 are provided in layer 12 nearer to layer 14 than to inflow side 20.

Reference is made to the general part of the description and, in addition, to the attached patent claims in regard to further advantageous embodiments and refinements of the teaching according to the present invention.

Finally, it is very particularly emphasized that the previously purely arbitrarily selected exemplary embodiments are only used to explain the teaching according to the present invention, but do not restrict this teaching to these exemplary embodiments.

What is claimed is:

1. A filter element having an inflow side and an outflow side comprising:
a filter body including a first layer on the inflow side, the first layer including including activated carbon fibers, and a second layer including granular adsorbents, the second layer adjoining the first layer on the outflow side.

2. The filter element as recited in claim 1 wherein the granular adsorbents include activated carbon.

3. The filter element as recited in claim 1 wherein the granular adsorbents include zeolites, cyclodextrins, silicates, ion exchangers, or aluminum silicates.

4. The filter element as recited in claim 1 wherein the filter body further includes a third layer including activated carbon fibers, the third layer adjoining the second layer.

5. The filter element as recited in claim 1 wherein the first layer or a further activated carbon fiber layer is a nonwoven layer.

6. The filter element as recited in claim 1 wherein the first layer or a further activated carbon fiber layer includes further fibers or particles in addition to the activated carbon fibers.

7. The filter element as recited in claim 1 wherein the second layer includes further fibers or particles in addition to the granular adsorbents.

8. The filter element as recited in claim 1 wherein the activated carbon fibers have diameter of at most 20 μm.

9. The filter element as recited in claim 2 wherein the granular activated carbon particles have a size which is in the range between 0.1 mm and 2 mm.

10. The filter element as recited in claim 1 wherein the second layer loaded with granular adsorbents has a load per unit area of 100 g/m² to 500 g/m².

11. The filter element as recited in claim 1 wherein the first layer or a further activated carbon fiber layer has a mass per unit area of 10 g/m² to 200 g/m².

12. The filter element as recited in claim 1 wherein the first and second layers intermesh.

13. The filter element as recited in claim 12 wherein the layers have areas of different material concentrations.

14. A filter system comprising a filter element as recited in claim 1 wherein unfiltered air loaded with adsorptives may flow against the first layer.
